(19) United States
(12) Patent Application Publication
(10) Pub. No.: US 2003/0027520 A1
(43) Pub. Date: Feb. 6, 2003

(54) Broadcast receiver capable of receiving broadcast data on the air, broadcast distribution device distributing that broadcast data, and broadcast distribution system for connection therebetween

(76) Inventor: Atsushi Yamashita, Nara-shi (JP)

Correspondence Address: BIRCH STEWART KOLASCH & BIRCH, PO BOX 747, FALLS CHURCH, VA, 22040-0747, US

(21) Appl. No.: 10/200,502

(22) Filed: Jul. 23, 2002

(30) Foreign Application Priority Data
Aug. 6, 2001 (JP) 2001-237890 (P)

(51) Int. Cl. H04H 1/00; H04H 7/00

(52) U.S. Cl. 455/3.04; 455/3.06

(57) ABSTRACT

A broadcast schedule of a broadcast station is stored in a third storage unit and music data is stored in a second storage unit according to the broadcast schedule. A control unit extracts, when a first communication unit receives a request for transmission of the music data, the music data stored in the second storage unit according to information about broadcast date and time that is included in the request for transmission and, transmitting the extracted music data by the first communication unit. In this way, broadcast data desired by a user is surely distributed and accordingly the user readily acquires the broadcast data.

### BACKGROUND OF THE INVENTION

1. Field of the Invention

The present invention relates to a technique of distributing broadcast information regarding radio broadcasting or TV (television) broadcasting for example. In particular, the present invention relates to a broadcast receiver allowing audiences to receive broadcast information and broadcast data on the air, a broadcast distribution device distributing such information and data, and a broadcast distribution system for connection between the broadcast receiver and the broadcast distribution device.

2. Description of the Background Art

The widespread TV receivers and radio sets allow audiences to select a desired program from various programs and accordingly enjoy the selected program. Some audiences viewing or listening to the TV or radio program on the air may desire to view or listen to the program again afterward. In particular, some audience enjoying a music program may eager to listen to a broadcast tune or song once again.

In such a case, if the audience knows the title of the tune or the name of the artist thereof (hereinafter referred to as music information), the audience can, for example, purchase a record or CD (Compact Disc) album including the desired tune based on the music information. However, if the audience does not know or forgets the music information, the audience has to wait for rebroadcast of the music program, or ask the broadcast station about the required music information by informing the station of the airtime, for example, of the music program and then purchase the record or CD album. If the audience is ignorant about the music information but remembers the lyrics or melody of the tune, the audience may take a considerable time to search for the record or CD album in any record/CD shops or rental shops.

In this way, the audience acquires such music information as the title of the tune or the name of the artist and then purchases the record or CD album according to the music information. It is thus necessary for the audience to actually visit any record/CD shop, which could be a factor of burdensomeness to the audience. Further, the tune is unavailable to the audience if no record or CD album including the tune is on the market or the record or CD album is out of print.

According to a recently proposed technique which is available now, music data regarding a desired tune is downloadable by accessing via the Internet a homepage of a record company or broadcast station for example from a personal computer or cellular phone and following a predetermined procedure. A conventional music distribution system is described below by which an audience who listens to a music broadcast downloads music data by means of a portable terminal such as cellular phone.

FIG. 1 schematically shows a structure of a conventional music distribution system using the Internet. The music distribution system includes a broadcast station 101 broadcasting a music program and the like, a sound system 102 receiving the broadcast program from broadcast station 101, a server system 103 distributing music data, a terminal device 104 by which an audience 105 listening to the music program through sound system 102 receives the music data distributed from server system 103, and a first data communication channel 106 through which data is communicated between server system 103 and terminal device 104.

Broadcast station 101 corresponding to an FM (frequency modulation) station for example broadcasts music or some information other than music all the time at a predetermined frequency. Sound system 102 corresponding to a radio receiver for example receives music and the like that is broadcast by broadcast station 101.

Server system 103 with two-way communication capability is able to transmit/receive information and data to/from terminal device 104 through the first data communication channel 106. For example, server system 103 corresponds to a server of a record company which distributes music, the server accumulating and distributing music information and music data opened to the public on a homepage of the record company. Server system 103 is accessed by audience 105 to provide music data regarding a tune designated by audience 105.

Terminal device 104 with two-way communication capability is able to transmit/receive information and data to/from server system 103 through the first data communication channel 106. Terminal device 104 corresponds to a cellular phone or mobile data terminal for example.

When audience 105 who is listening to a music tune supplied from broadcast station 101 desires to acquire music data of the music tune, audience 105 has to know the title of the broadcast tune or the name of the artist thereof first of all. There arises no particular problem if audience 105 knows the music information (tune title/artist name). However, if audience 105 does not know or forgets the music information, audience 105 has to obtain the information by oneself by asking broadcast station 101 about the information for example.

After audience 105 acquires the music information, audience 105 can use terminal device 104 to access server system 103 which provides the music data. Audience 105 then searches for the desired music data, extracts corresponding music information, and downloads the music data concerning the music information.

The conventional music distribution system described above has a following problem. When audience 105 does not know or forgets music information regarding a certain music tune which audience 105 is listening to, audience 105 has to ask broadcast station 101 about the music information for example, which could be a factor of burdensomeness to audience 105.

Another problem of the system is that, when audience 105 acquiring music information downloads music data concerning the music information from server system 103, it is necessary for audience 105 to firstly search for the title of the tune or the name of the artist thereof and then download the music data, which also could be a factor of burdensomeness to audience 105.

A further problem of the system is that, if the title of the tune or the name of the artist thereof regarding desired music data is wrong and thus downloaded music data is different from the desired music data, audience 105 wastes communication and download charges for example.

### SUMMARY OF THE INVENTION

One object of the present invention is to provide a broadcast distribution device, a broadcast distribution method, a computer program for broadcast distribution, a recording medium on which the computer program is recorded, a broadcast receiver, and a broadcast distribution system connecting them, allowing a user to readily acquire desired music data.

Another object of the present invention is to provide a broadcast distribution device, a broadcast distribution method, a computer program for broadcast distribution, a recording medium on which the computer program is recorded, a broadcast receiver, and a broadcast distribution system connecting them, preventing inappropriate music data from being downloaded erroneously.

According to one aspect of the present invention, a broadcast distribution device includes a storage unit storing broadcast data according to a broadcast schedule of a broadcast station, a communication unit transmitting/receiving data to/from an external unit, and a control unit extracting, when the communication unit receives a request for transmission of the broadcast data, the broadcast data stored in the storage unit according to information about broadcast date and time that is included in the request for transmission and, transmitting the extracted broadcast data by the communication unit.

The control unit thus extracts the broadcast data stored in the storage unit according to the information about broadcast date and time that is included in the transmission request and then transmits the extracted broadcast data by the communication unit. In this way, the broadcast data requested by the user is surely distributed and the user readily acquires the broadcast data.

According to another aspect of the present invention, a broadcast distribution method for distributing broadcast data includes the steps of storing broadcast data according to a broadcast schedule of a broadcast station, extracting, when a request for transmission of the broadcast data is received, the stored broadcast data according to information about broadcast date and time that is included in the request for transmission, and transmitting the extracted broadcast data.

The stored broadcast data is extracted and then transmitted according to the information about broadcast date and time that is included in the transmission request. In this way, the broadcast data requested by the user is surely distributed and the user readily acquires the broadcast data.

According to still another aspect of the present invention, a program product for executing by a computer a broadcast distribution method for distributing broadcast data is provided. The broadcast distribution method includes the steps of storing broadcast data according to a broadcast schedule of a broadcast station, extracting, when a request for transmission of the broadcast data is received, the stored broadcast data according to information about broadcast date and time that is included in the request for transmission, and transmitting the extracted broadcast data.

The stored broadcast data is extracted and then transmitted according to the information about broadcast date and time that is included in the transmission request. In this way, the broadcast data requested by the user is surely distributed and the user readily acquires the broadcast data.

According to a further aspect of the present invention, a computer-readable recording medium having a program recorded thereon that is used for executing by a computer a broadcast distribution method for distributing broadcast data is provided. The broadcast distribution method includes the steps of storing broadcast data according to a broadcast schedule of a broadcast station, extracting, when a request for transmission of the broadcast data is received, the stored broadcast data according to information about broadcast date and time that is included in the request for transmission, and transmitting the extracted broadcast data.

The stored broadcast data is extracted and then transmitted according to the information about broadcast date and time that is included in the transmission request. In this way, the broadcast data requested by the user is surely distributed and the user readily acquires the broadcast data.

According to a still further aspect of the present invention, a broadcast receiver includes a communication unit transmitting/receiving data to/from an external unit, and a control unit transmitting by the communication unit a request for transmission of broadcast data that includes information about broadcast date and time and receiving by the communication unit the broadcast data following the request for transmission.

The control unit transmits, by the communication unit, the request for transmission of broadcast data that includes information about broadcast date and time. Then, broadcast data requested by the user is readily specified and the user thus surely obtains the desired broadcast data.

According to a still further aspect of the present invention, a broadcast distribution system is provided that includes a broadcast distribution device distributing broadcast data and a broadcast receiver receiving the broadcast data that are connected by a network. The broadcast distribution device includes a first storage unit storing the broadcast data according to a broadcast schedule of a broadcast station, a first communication unit transmitting/receiving data to/from the broadcast receiver, and a first control unit extracting, when the first communication unit receives a request for transmission of the broadcast data, the broadcast data stored in the first storage unit according to information about broadcast date and time that is included in the request for transmission and, transmitting the extracted broadcast data by the first communication unit. The broadcast receiver includes a second communication unit transmitting/receiving data to/from the broadcast distribution device, and a second control unit transmitting by the second communication unit a request for transmission of the broadcast data that includes information about broadcast date and time and receiving by the second communication unit the broadcast data following the request for transmission.

The first control unit extracts the broadcast data stored in the first storage unit according to information about broadcast date and time that is included in the transmission request supplied from the broadcast receiver, and then the first control unit transmits the extracted broadcast data by the first communication unit. In this way, desired broadcast data requested by the user is surely distributed and the user readily acquires the broadcast data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a structure of a conventional music distribution system using the Internet.

FIG. 2 schematically shows a structure of a broadcast distribution system according to a first embodiment of the present invention.

FIG. 3 shows an exemplary external view of a server system 3 according to the first embodiment of the present invention.

FIG. 4 is a block diagram showing an exemplary structure of the server system 3 of the first embodiment.

FIG. 5 is a block diagram showing a functional structure of the server system 3 of the first embodiment.

FIG. 6 shows one example of user information stored in the first storage unit 32 of the server system 3.

FIG. 7 shows one example of music data and the information regarding the music data that are stored in the second storage unit 33 of the server system 3.

FIG. 8 shows one example of broadcast station information stored in the third storage unit 34 of the server system 3.

FIG. 9 is a block diagram showing a functional structure of a terminal device 4 of the first embodiment.

FIG. 10 shows one example of connected system information stored in the first storage unit 43 of the terminal device 4.

FIG. 11 shows one example of music data and information regarding the music data that are stored in the second storage unit 44 of the terminal device 4.

FIG. 12A shows an exemplary external view of a cellular phone 50 to be used as the terminal device 4, and FIGS. 12B to 12I show exemplary displays on a display unit 42.

FIG. 13 is a flowchart illustrating a procedure followed by a computer placed in a broadcast station and the server system 3.

FIG. 14 is a flowchart illustrating a procedure followed by the cellular phone 50 and the server system 3.

FIG. 15 is a block diagram schematically showing a structure of a broadcast distribution system according to a second embodiment of the present invention.

FIG. 16 is a block diagram showing a functional structure of a terminal device 4′ according to the second embodiment of the present invention.

FIG. 17 shows an example of broadcast station information stored in the fourth storage unit 51 of the terminal device 4′.

FIG. 18 shows an example of reception date and time information stored in the fifth storage unit 52 of the terminal device 4′.

FIG. 19 is a flowchart illustrating a procedure followed by the terminal device 4′ and the server system 3.

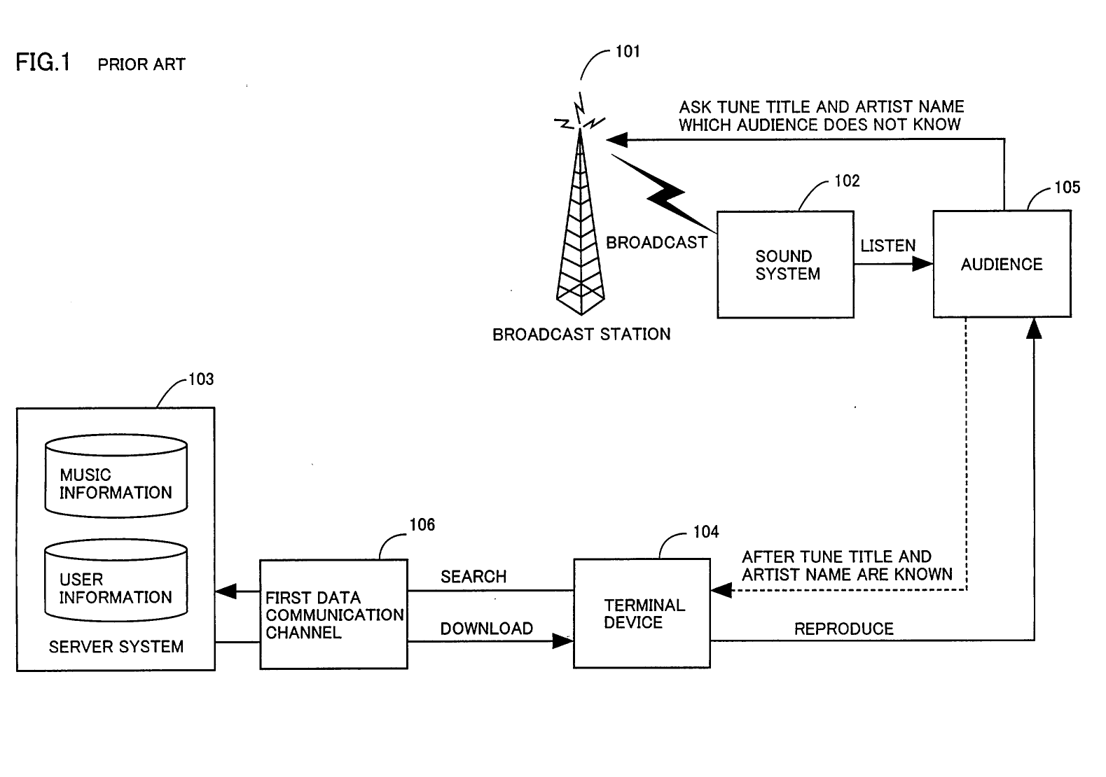

### DESCRIPTION OF THE PREFERRED EMBODIMENTS

First Embodiment

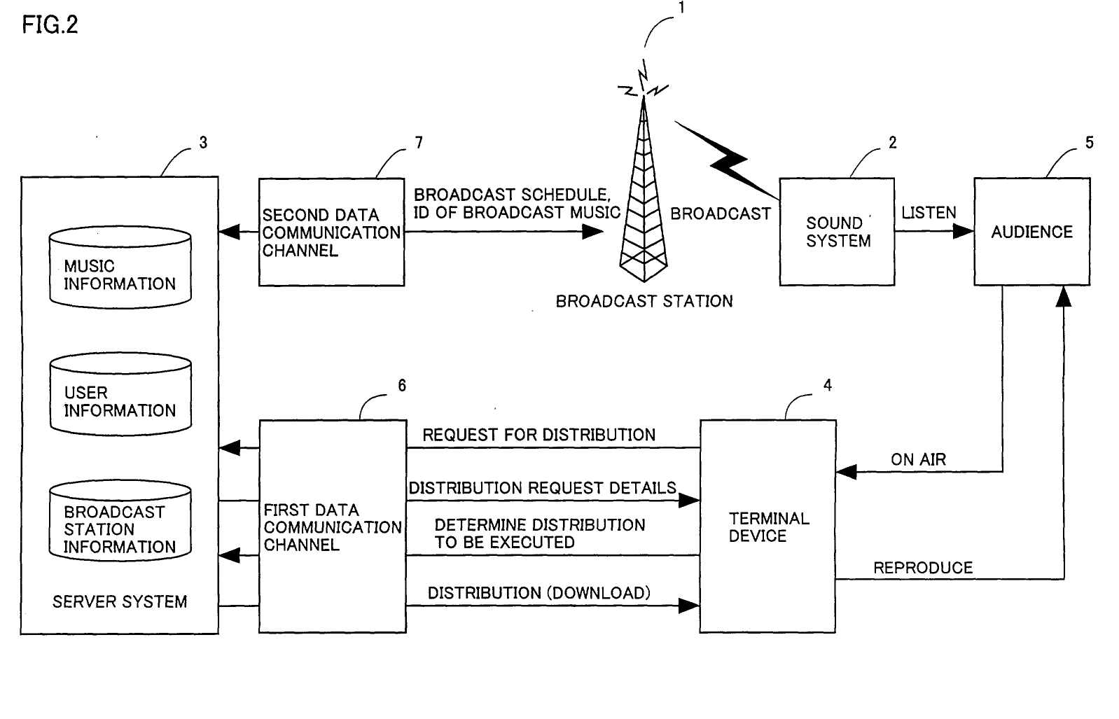

FIG. 2 schematically shows a structure of a broadcast distribution system according to a first embodiment of the present invention. The broadcast distribution system includes a broadcast station 1 broadcasting a music program and the like, a sound system 2 receiving the broadcast music program from broadcast station 1, a server system 3 distributing music data and the like, a terminal device 4 by which an audience 5 listening to the music program for example through sound system 2 receives the music data distributed from server system 3, a first data communication channel 6 through which data is communicated between server system 3 and terminal device 4, and a second data communication channel 7 through which data is communicated between broadcast station 1 and server system 3. It is noted that, although the broadcast distribution system of the first embodiment is described that distributes music data, the broadcast distribution system may distribute such data as image data.

Broadcast station 1 corresponding to an FM station for example broadcasts music or other programs all the time at a predetermined frequency. Sound system 2 corresponding to a radio receiver, TV receiver or the like receives a music program for example that is broadcast by broadcast station 1.

Server system 3 has two-way communication capability. Server system 3 receives and accumulates music information and music data for example that are transmitted from a computer (not shown) placed in broadcast station 1 through the second data communication channel 7. The music information regarding music data refers to a broadcast schedule of a music program to be broadcast, the title of a music tune and the name of an artist for example. The music information and music data to be broadcast are regularly downloaded in advance into server system 3 before broadcast.

If any change is made in the broadcast schedule for example, the information accumulated in server system 3 is appropriately updated. Server system 3 may confirm broadcast information for example by accessing the computer in broadcast station 1 through the second data communication channel 7. As described later, server system 3 manages identifying information of users of the broadcast distribution system and charge for using the broadcast distribution system for example.

Terminal device 4 with two-way communication capability is able to transmit/receive information and data to/from server system 3 through the first data communication channel 6. Terminal device 4 corresponds to a cellular phone or mobile data terminal for example.

When audience 5 who is listening to a music program supplied from broadcast station 1 desires to obtain music data of a music tune which audience 1 is listening to, audience 1 uses terminal device 4 to transmit information indicating a request for distribution of the music data through the first data communication channel 6 to server system 3. The information indicating the request for distribution includes information for identifying the broadcast station (e.g. the name of the station, broadcast frequency), the broadcast date, and information for identifying the audience who requests distribution (e.g. user ID).

Server system 3 which receives the request for distribution of the music data from audience 5 refers to identifying information regarding users (audience 5) that have already been registered to determine if the request is an appropriate one or not. If appropriate, server system 3 in return transmits information regarding the music data of that music tune to terminal device 4 used by audience 5 and asks if audience 5 requests distribution of the music data. The information transmitted from server system 3 in return to terminal device 4 includes attribute information of the music tune such as the title of the tune, the name of the artist, the name of the copyright owner, the size of the music data, and the distribution charge.

Audience 5 refers to the information regarding the music data supplied from server system 3 to determine if audience 5 requests distribution of the music data or not. If audience 5 requests distribution, audience 5 transmits this request in return to server system 3. Server system 3 then transmits data for directing audience 5 to input a password to terminal device 4 if audience 5 requests distribution of the music data.

Audience 5 accordingly inputs a password which is transmitted from terminal device 4 to server system 3. If the password is an appropriate one, server system 3 transmits the music data requested by audience 5 to terminal device 4 and the music data is accordingly downloaded. Audience thus can listen to the desired music tune by reproducing the downloaded music data by means of sound system 2 or a reproduction device (not shown).

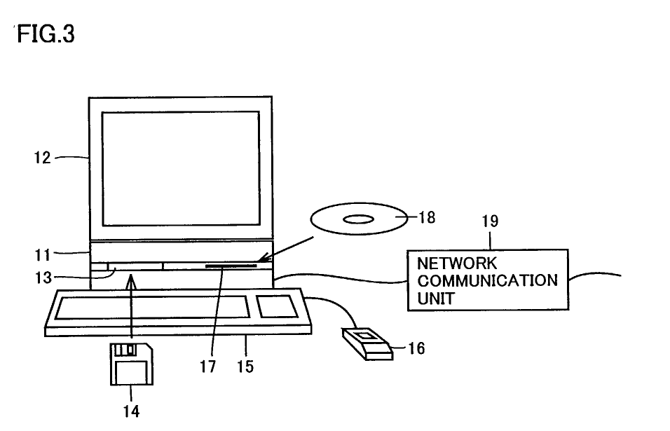

FIG. 3 shows an exemplary external view of server system 3 according to the first embodiment of the present invention. Server system 3 includes a computer body 11, a display unit 12, an FD drive 13 with an FD (flexible disk) 14 placed therein, a keyboard 15, a mouse 16, a CD-ROM unit 17 with a CD-ROM (compact disc-read only memory) 18 placed therein, and a network communication unit 19. A broadcast distribution program is supplied by such a recording medium as FD 14 or CD-ROM 18. The broadcast distribution program is executed in computer body 11 to distribute music data to audience 5. The broadcast distribution program may be supplied to computer body 11 from another computer through the first data communication channel 6.

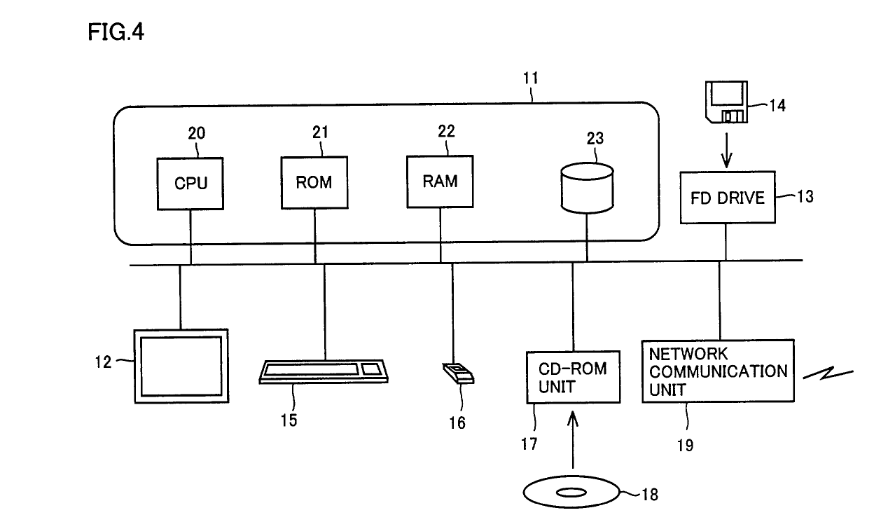

FIG. 4 is a block diagram showing an exemplary structure of server system 3 of the first embodiment. Computer body 11 shown in FIG. 3 includes a CPU (central processing unit) 20, a ROM (read-only memory) 21, a RAM (random-access memory) 22, and a hard disk 23. CPU 20 carries out its processing by supplying/receiving data to/from display unit 12, FD drive 13, keyboard 15, mouse 16, CD-ROM unit 17, network communication unit 19, ROM 21, RAM 22 or hard disk 23. The broadcast distribution program recorded on FD 14 or CD-ROM 18 is temporarily stored by CPU 20 in hard disk 23 through FD drive 13 or CD-ROM unit 17. CPU 20 appropriately loads the broadcast distribution program from hard disk 23 to RAM 22 and executes the program to distribute music data to audience 5.

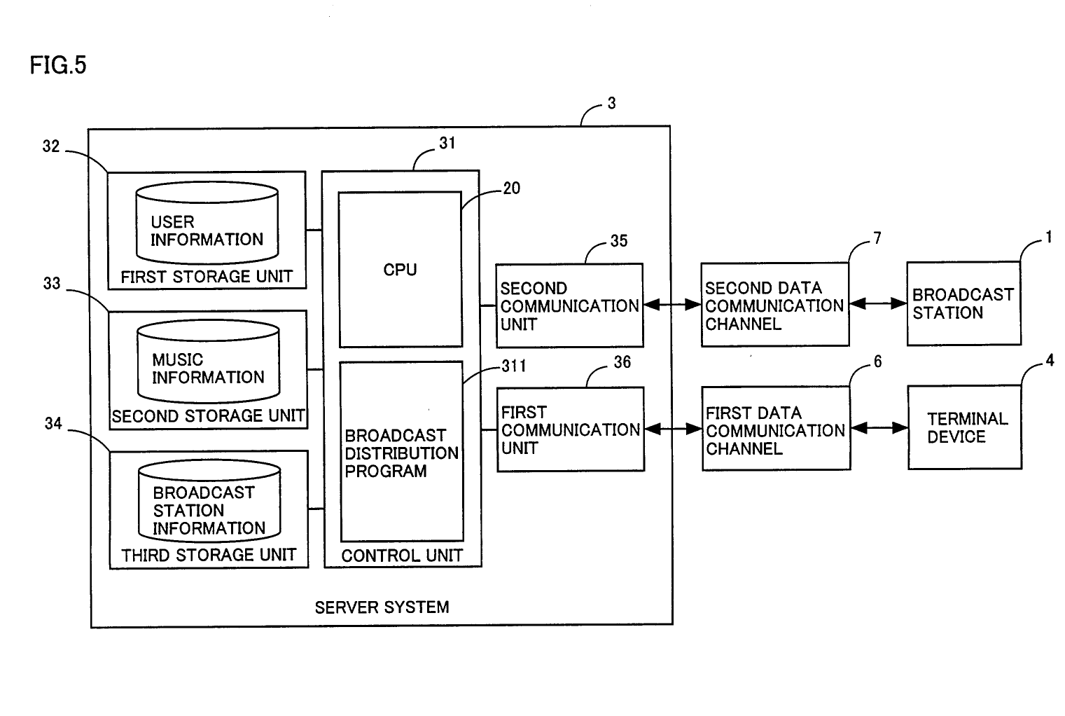

FIG. 5 is a block diagram showing a functional structure of server system 3 of the first embodiment. Server system 3 includes a control unit 31 for general control of server system 3, a first storage unit 32 storing user information, a second storage unit 33 storing music data as well as music information regarding the music data, a third storage unit 34 storing broadcast station information as described later, a second communication unit 35 transmitting/receiving data to/from the computer placed in broadcast station 1 through the second communication channel 7, and a first communication unit 36 transmitting/receiving data to/from terminal device 4 through the first data communication channel 6.

Control unit 31 is constituted of CPU 20 and broadcast distribution program 311. CPU 20 executes broadcast distribution program 311 to control the whole of server system 3.

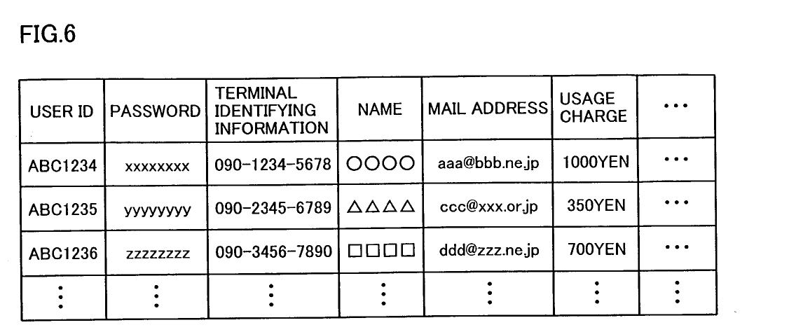

FIG. 6 shows one example of user information stored in the first storage unit 32 of server system 3. Referring to FIG. 6, the user information includes a user ID which is an identifying number of a user (audience 5) of the broadcast distribution system, a password of the user, terminal identifying information (e.g. phone number) for identifying terminal device 4 used by the user, the name of the user, a mail address of the user, and usage charge, for example.

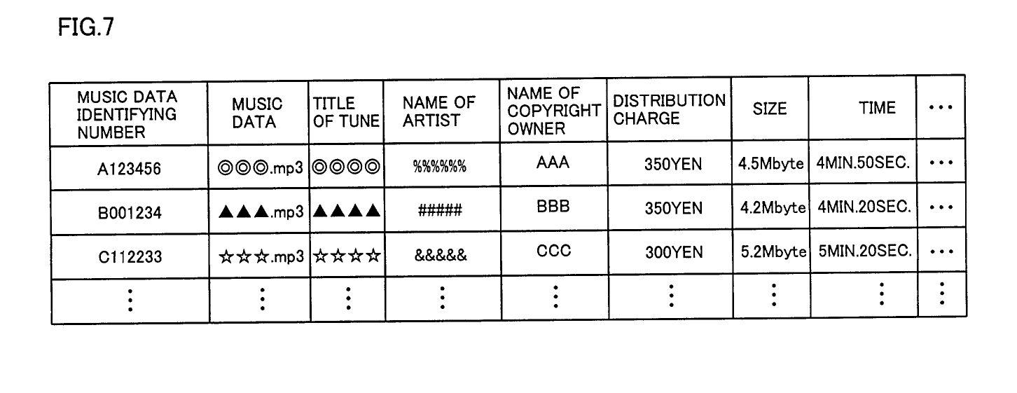

FIG. 7 shows one example of the music data and the information regarding the music data that are stored in the second storage unit 33. Referring to FIG. 7, the information regarding the music data includes such information as a music data identifying number which is information for identifying music data to be distributed, a file name of the music data, the title of a music tune, the name of the artist, the name of the copyright owner, distribution charge, size of the music data, time required for reproducing the music data, for example. Here, the music data refers to a music file itself.

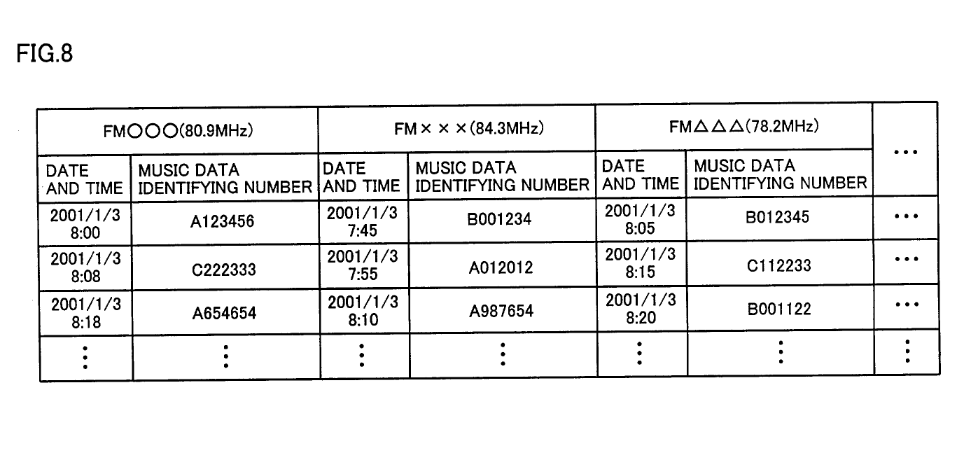

FIG. 8 shows one example of the broadcast station information stored in the third storage unit 34. Referring to FIG. 8, the broadcast station information includes a broadcast station ID (e.g. broadcast frequency) for identifying the broadcast station, broadcast date and time, and a music data identifying number for identifying a music tune to be broadcast, for example.

The first communication unit 36 with two-way communication capability is able to transmit/receive data to/from terminal device 4 used by audience 5 through the first data communication channel 6. The first communication unit 36 includes functions of receiving from audience 5 information regarding music data as well as information indicating a request for distribution of the music data, transmitting to audience 5 information necessary for allowing audience 5 to select music data to be distributed, receiving the result of selection by audience 5, and transmitting the music data requested by audience 5.

The second communication unit 35 with two-way communication capability is able to transmit/receive data to/from the computer placed in broadcast station 1 through the second data communication channel 7. The second communication unit 35 receives in advance, from the computer placed in broadcast station 1 through the second data communication channel 7, a broadcast schedule, music information to be broadcast and music data for example. The information regarding music data as well as music data are stored in the second storage unit 33 while the broadcast station information is stored in the third storage unit 34. If any change is made in the broadcast schedule for example, the change in the information is transmitted, on regular basis or each time the change is made, to server system 3 from the computer placed in broadcast station 1. Thus, server system 3 always stores the latest information. Server system 3 may access the computer in broadcast station 1 to confirm broadcast information for example.

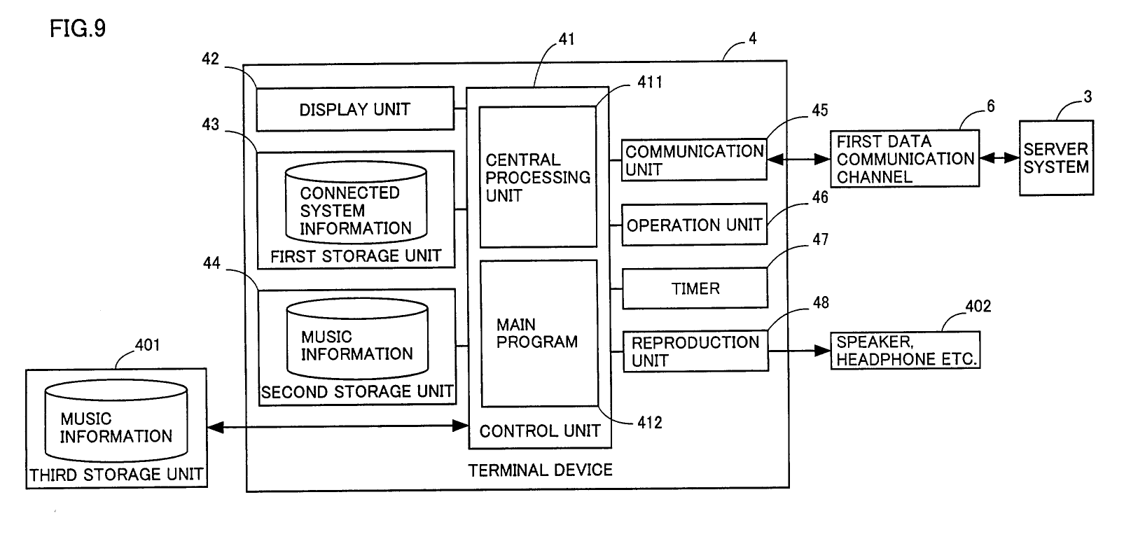

FIG. 9 is a block diagram showing a functional structure of terminal device 4 of the first embodiment. Terminal device 4 includes a control unit 41 for general control of the terminal device, a display unit 42 displaying various types of information, a first storage unit 43 storing connected system information described later, a second storage unit 44 storing music data and information regarding the music data, a communication unit 45 transmitting/receiving data to/from server system 3 through the first data communication channel 6, an operation unit 46 for inputs of various types of information, a timer 47, and a reproduction unit 48 reproducing music data.

Control unit 41 includes a central processing unit 411 and a main program 412. Central processing unit 411 executes main program 412 to control display unit 42, communication unit 45, operation unit 46, and reproduction unit 48, for example.

Display unit 42 is formed of a liquid-crystal display panel for example. Audience 5 refers to contents indicated on display unit 42 to input a request for distribution of music data and input a password, for example.

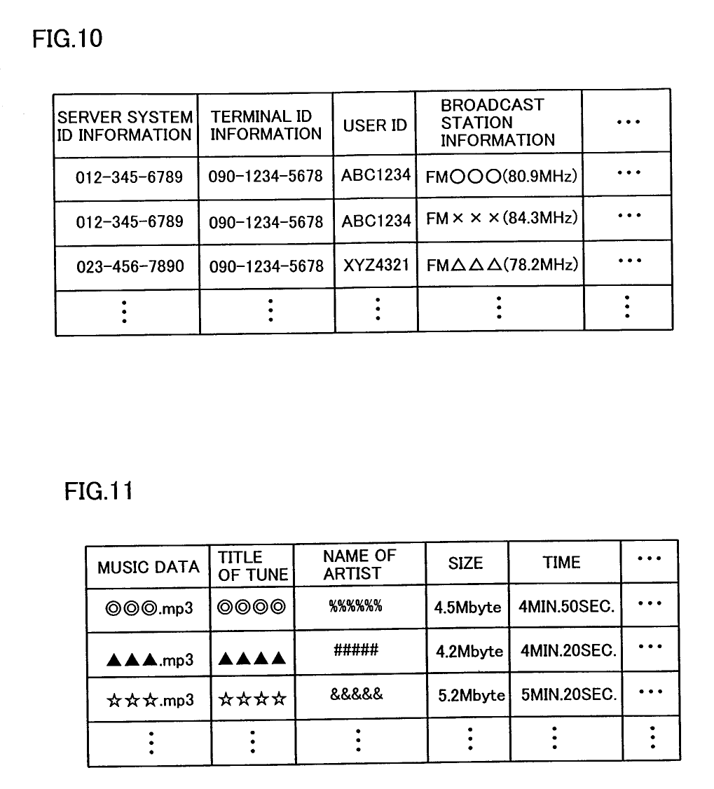

The first storage unit 43 stores connected system information for connection to server system 3. FIG. 10 shows one example of the connected system information stored in the first storage unit 43. Referring to FIG. 10, the connected system information includes server system identifying information (e.g. phone number, server ID) for identifying server system 3, terminal identifying information (e.g. phone number of terminal device 4, terminal ID) for allowing server system 3 to identify terminal device 4 used by a user, a user ID for allowing server system 3 to identify the user, and broadcast station information (e.g. name of the broadcast station, broadcast frequency), for identifying broadcast station 1, for example.

The second storage unit 44 stores music data and information regarding the music data that are acquired from server system 3. FIG. 11 shows one example of music data and information regarding the music data that are stored in the second storage unit 44. Referring to FIG. 11, the information includes a file name of music data and information regarding the music data such as the title of a music tune, the name of the artist, the size of the music data and the time required for reproducing the music data.

Communication unit 45 with two-way communication capability transmits/receives data to/from server system 3 through the first communication channel 6. Operation unit 46 is used by audience 5 to operate terminal device 4. Operation unit 46 is constituted of a switch and a keyboard for example.

Timer 47 with clocking capability manages the date and time when data is transmitted/received by communication unit 45. Reproduction unit 48 connected to a speaker/headphone 402 for example reproduces music data stored in the second storage unit 44 or the third storage unit 401 to output the reproduced music data to speaker/headphone 402 for example.

A user (audience 5) of the broadcast distribution system of the first embodiment is required to contract in advance with a manager of server system 3 concerning usage of this system. Although this contract could be made by sending necessary document by mail from the user, the user may make the contract online by means of terminal device 4 as described below.

The user uses terminal device 4 to connect to server system 3 and then transmits information necessary for requesting issuance of a user ID. Server system 3 receives this request to transmit to terminal device 4 information about the contract such as stipulations regarding usage of the broadcast distribution system. Terminal device 4 accordingly displays this information about the contract on display unit 42.

The user checks the information concerning the contract indicated on display unit 42 to transmit, if the user intends to make the contract, data indicative of this intention, to server system 3 through communication unit 45 and the first data communication channel 6.

Server system 3 then receives, from the user, the data indicative of the user's intention to make the contract to successively transmit, to terminal device 4 of user 4, messages for asking the user to register such user information as terminal identifying information (e.g. phone number), a password, the name of the user, and a mail address. The user refers to the messages indicated on display unit 42 to input details of the user information successively. The details of the user information are then transmitted successively to server system 3 through communication unit 45 and the first data communication channel 6.

After server system 3 receives all of the details of the user information from terminal device 4, server system 3 issues the user ID to the user and registers the user information in the first storage unit 32. The user registers the user ID supplied from server system 3 in the first storage unit 43 of terminal device 4. Although the whole of the contract is made online as described above, the contract may partially be made by mail for example.

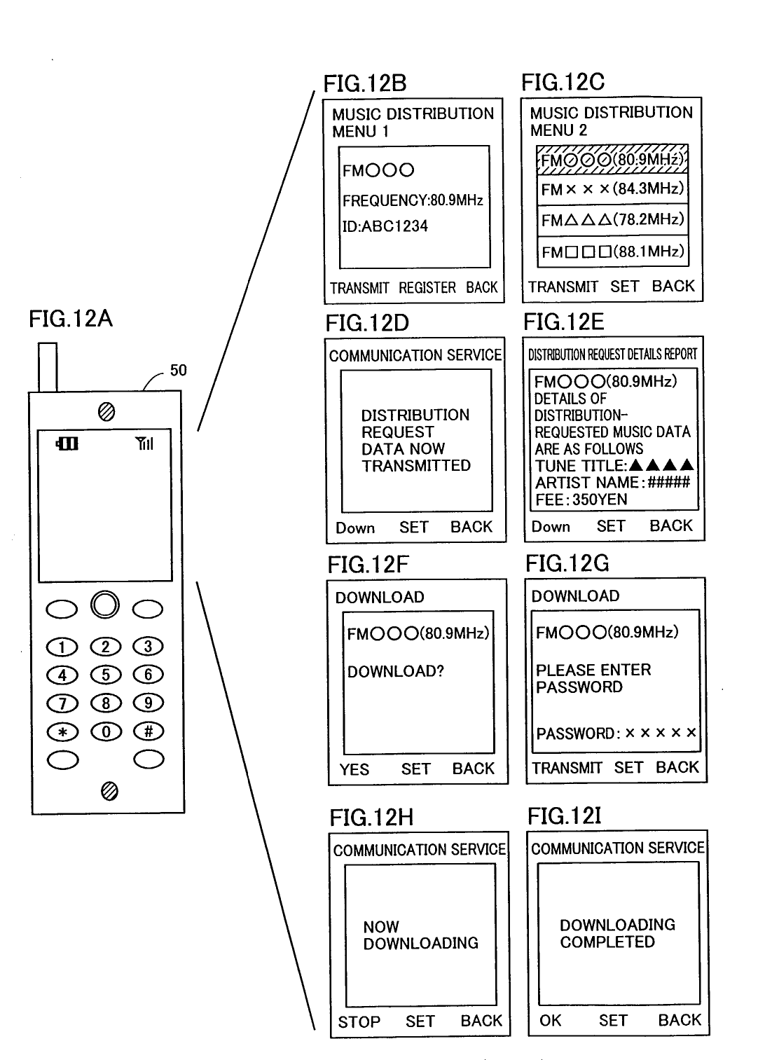

FIG. 12A shows an exemplary external view of a cellular phone 50 to be used as terminal device 4. FIGS. 12B to 12I show exemplary displays on display unit 42. Referring to FIG. 12B, a user who desires distribution of music enters, in advance, such connected system information as the name and broadcast frequency of each broadcast station as well as the user ID for each server system. The entered information is stored in the first storage unit 43 of cellular phone 50. As shown in FIG. 12C, display unit 42 indicates a list of such information items as respective names of broadcast stations that are entered by the user.

The user selects one of the broadcast stations or broadcast frequencies indicated on display unit 42. Then, as shown in FIG. 12D, a massage “distribution request data now transmitted” is indicated on display unit 42 and accordingly the distribution request data is transmitted to server system 3 through communication unit 45 and the first data communication channel 6. To the distribution request data including the connected system information of the selected broadcast station, information about the transmission date and time is automatically added that is obtained from timer 47 included in cellular phone 50.

Referring to FIG. 12E, display unit 42 of cellular phone 50 indicates information regarding music data with distribution thereof requested by the user, the information regarding the music data being supplied from server system 3 through the first data communication channel 6. The user refers to the information regarding the music data to consider whether the user downloads the music data or not.

Referring to FIG. 12F, a message indicated on display unit 42 states that if the music data is to be downloaded or not. If the user selects execution of downloading, display unit 42 as shown in FIG. 12G indicates a message to ask the user to enter the password. After the user enters the password, the password and data indicative of the determination that distribution should be executed (execute-distribution data) are transmitted to server system 3.

Server system 3 then receives the execute-distribution data and the password of the user, and checks the password against the password of the user registered in advance in the first storage unit 32 to determine if execution of distribution is appropriate or not. If server system 3 determines that the execution of distribution is appropriate, server system 3 transmits to cellular phone 50 the music data with its distribution requested by the user. During the period in which the music data is downloaded into cellular phone 50, a message “now downloading” is displayed as shown in FIG. 12H.

After downloading of the music data, server system 3 calculates the cost for distribution of the music data and the resultant accounting data is registered in the user information stored in the first storage unit 32. Referring to FIG. 12I, completion of the downloading of the music data is shown as a message on display unit 42. If the user desires distribution of music data that was broadcast in the past, the user has to transmit the broadcast date and time to server system 3.

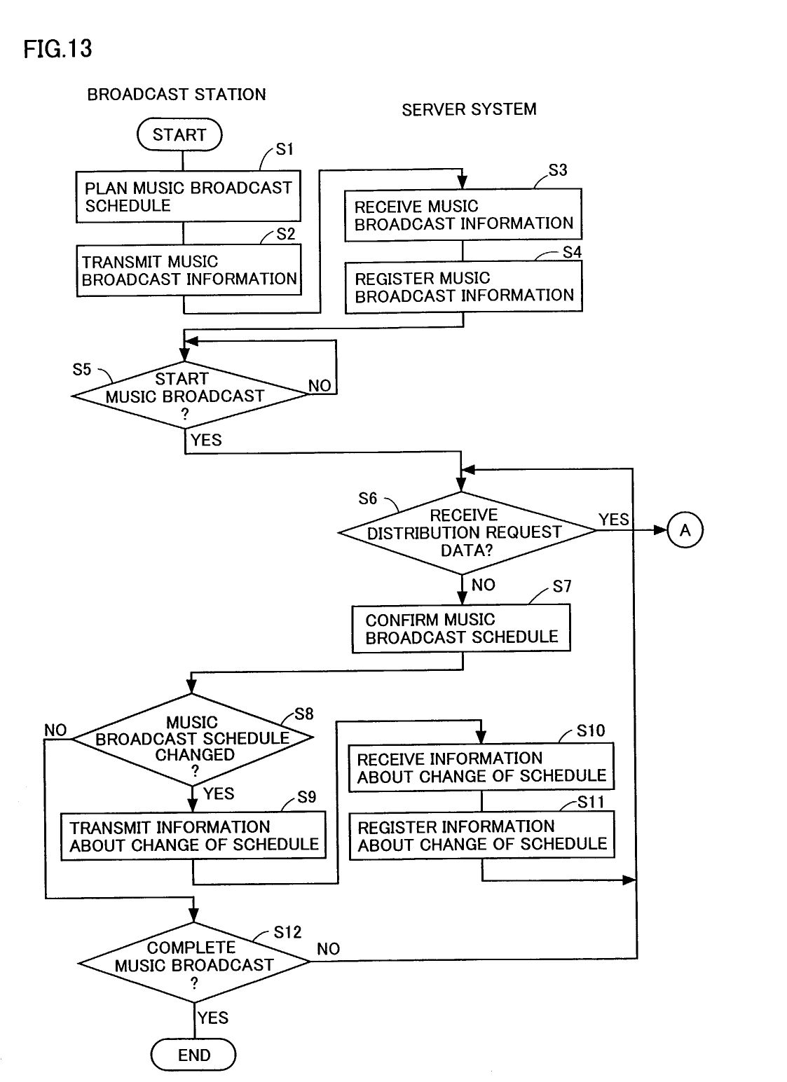

FIG. 13 is a flowchart illustrating a procedure followed by the computer placed in broadcast station 1 and server system 3. Broadcast station 1 regularly lays out a schedule of music programs to be broadcast (S1). The schedule of music programs is transmitted, as music broadcast information, through the data communication channel 7 to server system 3 on regular basis or each time any change is made in the schedule (S2). The music broadcast information includes music data and information regarding the music data as described above.

Server system 3 receives the music broadcast information from the computer in broadcast station 1 (S3) to register in the second storage unit 33 the music data and such information regarding the music data as the title of a music tune that are included in the music broadcast information, and register in the third storage unit 34 such information regarding the music data as broadcast station ID and broadcast date and time that is included in the music broadcast information (S4).

Broadcast station 1 starts broadcasting of music programs according to the schedule (S5, Yes), and server system 3 determines if distribution request data for certain music data is received or not (S6). Here, the start of broadcasting means that broadcast station 1 starts broadcasting of music programs for the day.

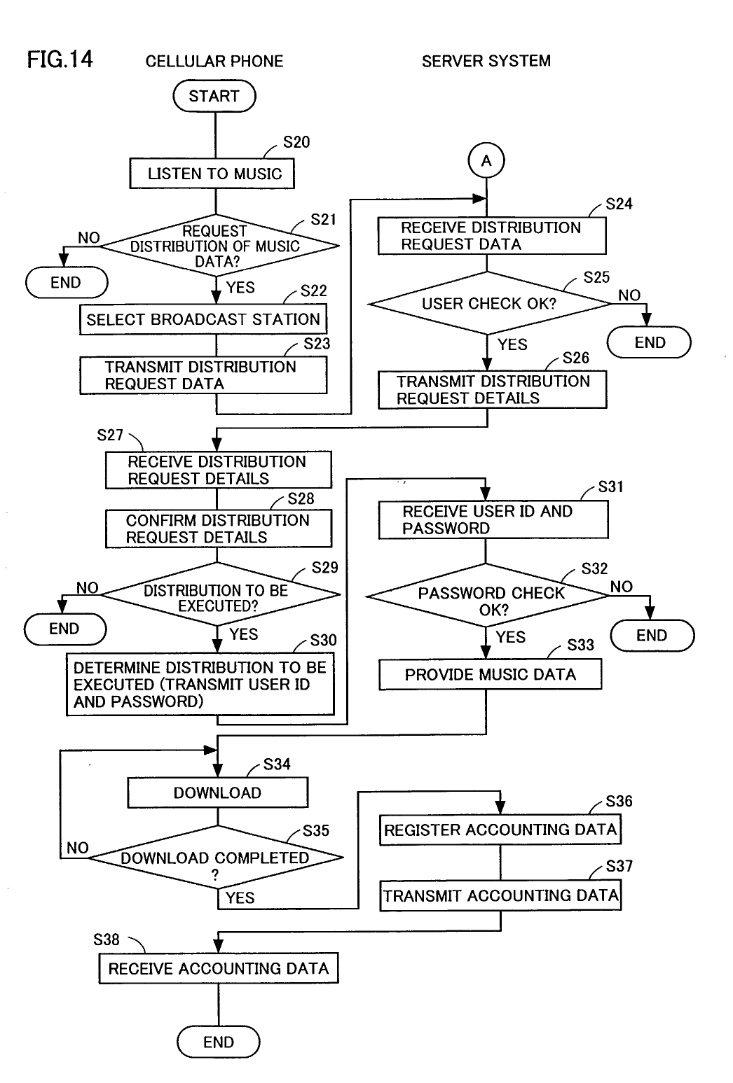

If server system 3 receives distribution request data (S6, Yes), the subsequent process indicated by A in FIG. 14 is carried out. If server system 3 does not receive distribution request data (S6, No), server system 3 appropriately transmits, to the computer in broadcast station 1, data for confirming the broadcast schedule (S7).

If any change is made in the music broadcast schedule (S8, Yes), broadcast station 1 corrects the broadcast schedule and transmits corrected information regarding music data as well as the music data to server system 3 (S9). If no change is made in the music broadcast schedule (S8, No) and broadcast station 1 has not completed music broadcasting (S12, No), the procedure returns to step S6 to follow the subsequent steps again. If broadcast station 1 has completed music broadcasting (S12, Yes), this procedure reaches the end.

Server system 3 receives information about the change in the schedule from the computer placed in broadcast station 1 (S10) to register, in the second storage unit 33, music data and such information regarding the music data as the title of a music tune and resister, in the third storage unit 34, such information regarding the music data as broadcast station ID and broadcast date and time (S11). Here, the information registered in the second and third storage units 33 and 34 is included in the information about the change in the schedule. Then, the procedure returns to step S6 to follow the subsequent steps again.

Server system 3 thus regularly follows steps S7 to S11 to acquire the latest broadcast information from broadcast station 1 all the time.

FIG. 14 is a flowchart illustrating a procedure followed by cellular phone 50 and server system 3. If audience 5 listening to a music program broadcast by broadcast station 1 (S20) desires distribution of music data (S21, Yes), display unit 42 of cellular phone 50 indicates names of broadcast stations or broadcast frequencies that are included in the connected system information registered in the first storage unit 43. Then, the user (audience 5) selects the corresponding broadcast station (S22), and communication unit 45 of cellular phone 50 transmits distribution request data through the first data communication channel 6 to server system 3 (S23).

At this time, cellular phone 50 adds, to the distribution request data transmitted to server system 3, information about the date and time (broadcast date and time) obtained from timer 47 included in cellular phone 50 as well as user information registered in the first storage unit 43. If the user requests distribution of music data which was broadcast in the past, the broadcast date and time of the music data is added to the distribution request data transmitted to server system 3 so as to receive distribution of the music data.

Server system 3 accordingly receives from cellular phone the distribution request data for the music data (S24), and checks the user information supplied from the user against user information stored in the first storage unit 32 in order to determine if the user who is requesting distribution is a user authorized to use the broadcast distribution system (S25). Preferably, items to be checked include at least the user ID.

If this check indicates that the user requesting distribution has not been authorized to use the broadcast distribution system (S25, No), server system 3 terminates the process. If the user requesting distribution has been authorized to use the broadcast distribution system (S25, Yes), reference is made to information for identifying broadcast station 1 and the broadcast date and time that are supplied from cellular phone 50 as well as the broadcast schedule stored in the third storage unit 34 so as to extract a corresponding music data ID number and transmit, to cellular phone 50 of the user, information about music data (contents with distribution thereof requested by the user) stored in the second storage unit 33 (S26).

Cellular phone 50 then receives the information about the music data from server system 3 (S27), and display unit 42 indicates the whole or part of the information about the music data to direct the user to confirm the contents with distribution thereof requested by the user. (S28). If the user does not desire distribution of the music data (S29, No), this process is ended. If the user determines that distribution of the music data should be executed (S29, Yes), cellular phone 50 transmits to server system 3 information indicating that distribution is to be executed (execute-distribution information) (S30). This execute-distribution information preferably includes the user ID and password registered in the first storage unit 32 of server system 3.

Server system 3 receives the execute-distribution information from cellular phone 50 (S31) and then checks the user information registered in advance in the first storage unit 32 of server system 3 with the user information included in the execute-distribution information supplied from cellular phone 50 to determine if the user is an appropriate (authorized) user or not (S32). If the user is an inappropriate user (S32, No), this process is ended. If the user is an appropriate user (S32, Yes), distribution of the music data with its distribution requested by the user is started (S33).

Cellular phone 50 thus downloads the music data transmitted from server system 3 and stores the music data in the second storage unit 44 of cellular phone 50 (S34). The music data may be stored in the external third storage unit 401 located outside the cellular phone 50.

After downloading of music data by cellular phone 50 (S35, Yes) server system 3 calculates the cost required for distribution of the music data to register the cost as accounting data in the first storage unit 32 in which the user information is registered (S36). Details of the accounting data generated by this distribution are transmitted to cellular phone 50 (S37). Cellular phone 50 receives the accounting data (S38) to break connection with server system 3, and thus distribution of the music data is completed.

Then, the user can use reproduction unit 48 to reproduce the music data stored in the second storage unit 44 or the third storage unit 401 and accordingly listen to desired music output from speaker/headphone 402.

According to the broadcast distribution system of the first embodiment as discussed above, audience 5 can acquire desired music data by merely transmitting, from terminal device 4 to server system 3, information indicating that audience 5 requests distribution of the music data. Thus, even if audience 5 does not know or forgets music information regarding a music tune which audience 5 is listening to, audience 5 can readily obtain the music data.

Further, search for the title of a desired music tune or the name of the artist for downloading of music data, which is troublesome to audience 5, is unnecessary. Thus, it is possible for audience 5 to obtain the music data without the troublesome process.

Moreover, even if the title of a music tune desired by audience 5 or the name of the artist is incorrect, it never occurs that inappropriate music data is erroneously downloaded and thus wasteful communication cost and download fee are avoided.

Second Embodiment

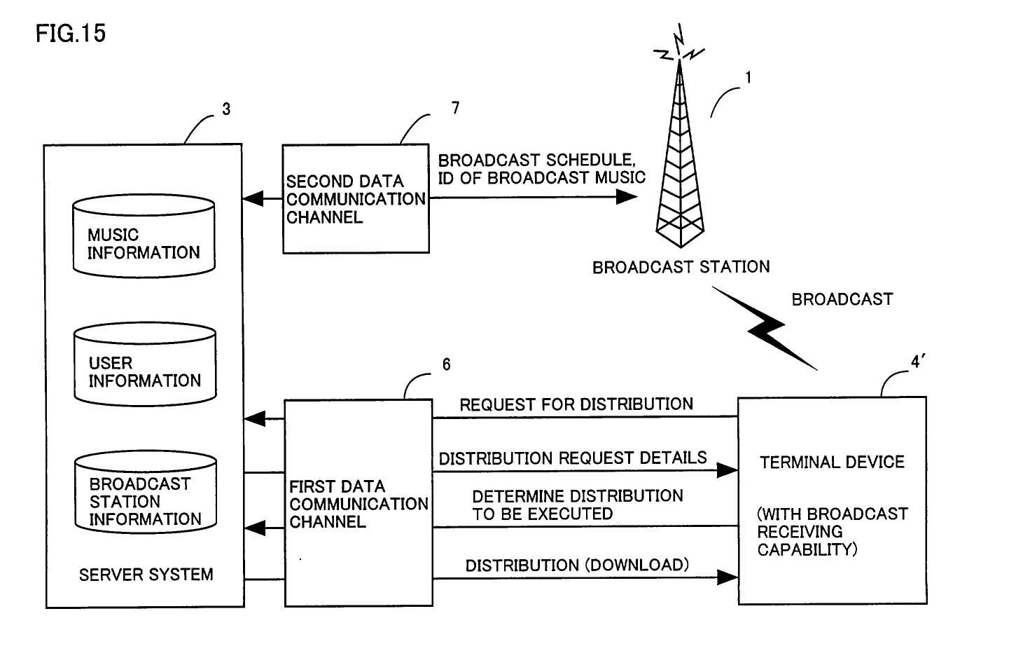

FIG. 15 is a block diagram schematically showing a structure of a broadcast distribution system according to a second embodiment of the present invention. The broadcast distribution system of the second embodiment differs from that of the first embodiment only in that a terminal device of the second embodiment is capable of receiving a music program for example broadcast by broadcast station 1. Components and functions common to the first and second embodiments are not described in detail below. It is noted that the terminal device of the second embodiment is denoted by reference character 4′ and accordingly described.

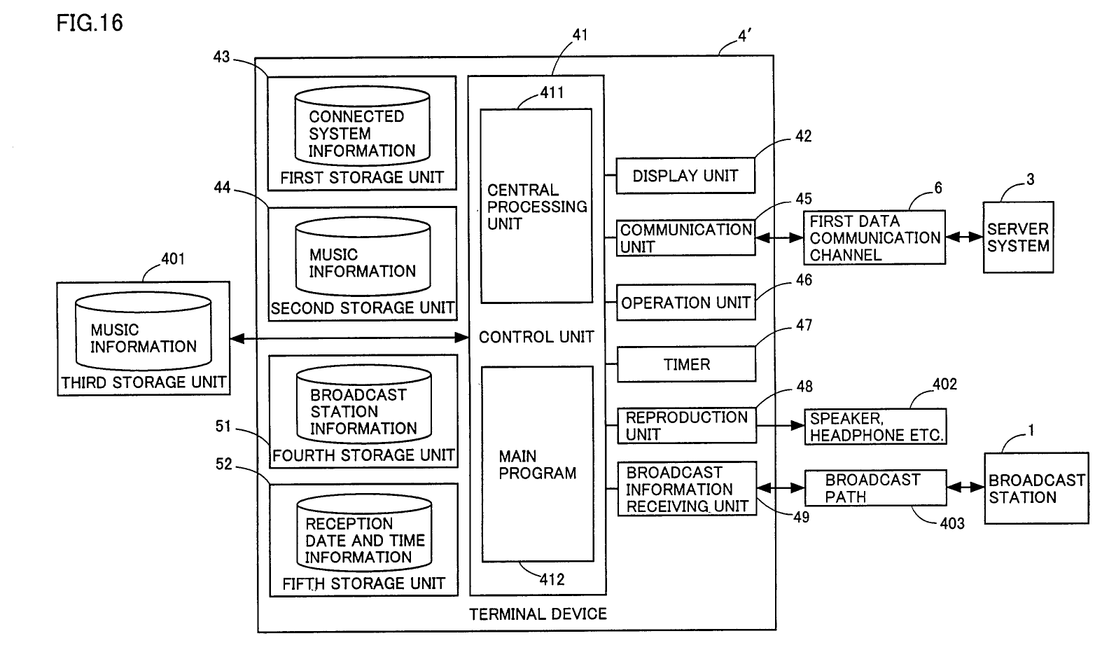

FIG. 16 is a block diagram showing a functional structure of terminal device 4′ according to the second embodiment of the present invention. Terminal device 4′ differs from terminal device 4 of the first embodiment shown in FIG. 9 in that the former terminal device 4′ additionally includes a broadcast information receiving unit 49 receiving a music program for example that is broadcast by broadcast station 1 through a broadcast path 403, a fourth storage unit 51 storing broadcast station information (e.g. name of broadcast station, broadcast frequency) necessary for receiving broadcast music, and a fifth storage unit 52 storing the date and time when the broadcast music is received as well as broadcast station information. Components and functions common to the first and second embodiments are not described in detail below.

When the broadcast music is received from broadcast station 1, control unit 41 receives from timer 47 the broadcast date and time as information about reception date and time. The reception date and time information is then stored in the fifth storage unit 52 together with information about a broadcast station selected by the user.

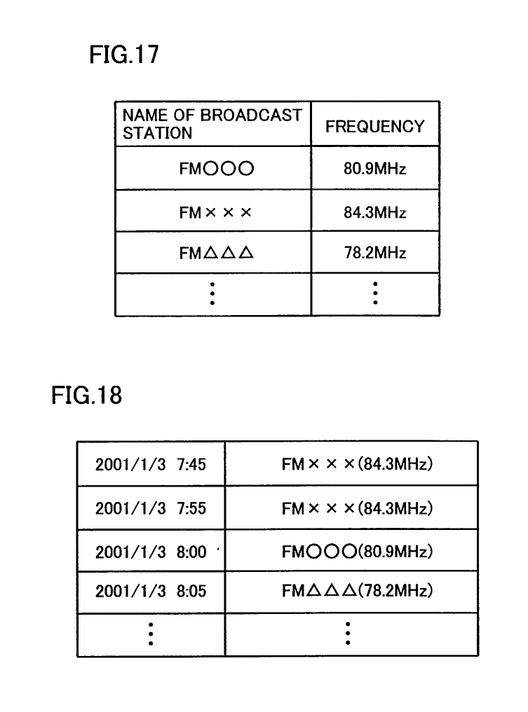

FIG. 17 shows an example of broadcast station information stored in the fourth storage unit 51. The broadcast station information includes the name and frequency of a broadcast station. The broadcast station information is stored in advance in the fourth storage unit 51.

FIG. 18 shows an example of the reception date and time information stored in the fifth storage unit 52. As shown in FIG. 18, the reception date and time information is stored together with the broadcast station information according to an instruction by an audience 5 (user) listening to a music program broadcast by broadcast station 1.

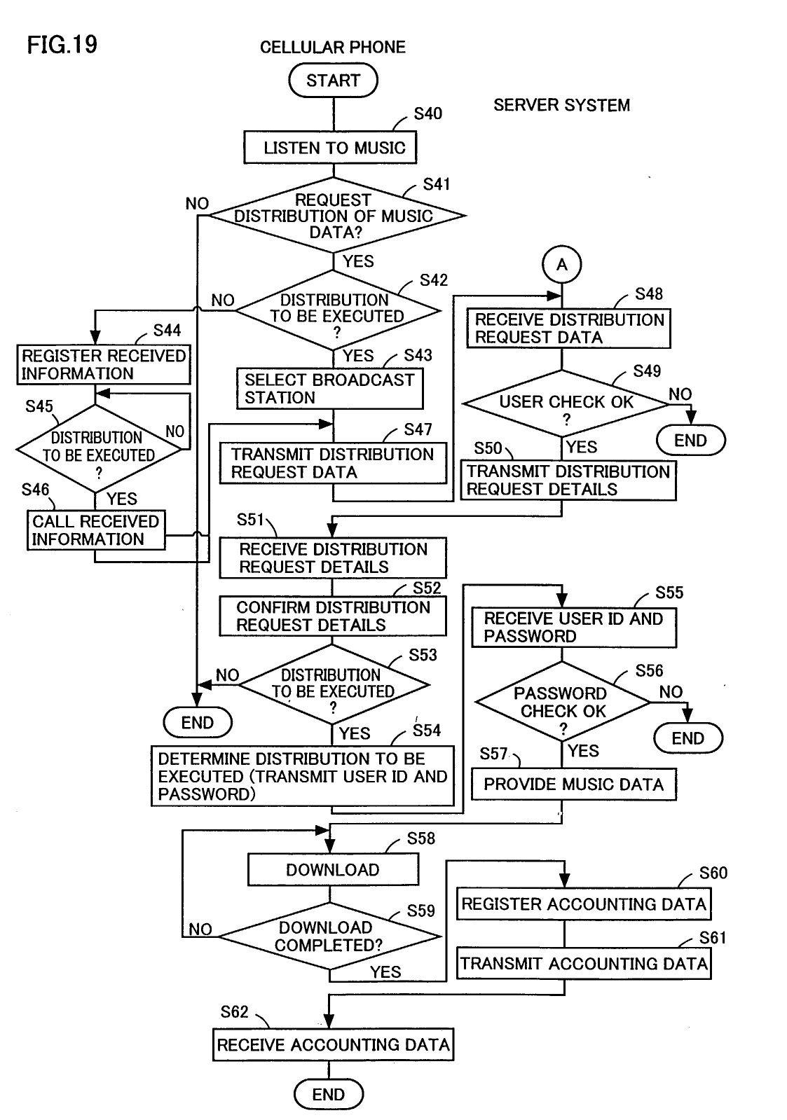

FIG. 19 is a flowchart illustrating a procedure followed by terminal device 4′ and server system 3. Audience 5 who is listening to a music program broadcast by broadcast station 1 (S40) determines if audience 5 desires distribution of music data or not (S41). If audience 5 desires distribution of music data (S41, Yes), it is determined if distribution of music data which audience 5 is now listening to is to be executed or not (S42). This determination is made by audience 5 through manipulation of operation unit 46 when audience 5 is listening to the music program.

When it is determined that distribution of music data which audience 5 is listening to is to be executed (S42, Yes), the broadcast station which is broadcasting the music data is selected (S43). Communication unit 45 of terminal device 4′ thus transmits distribution request data through the first data communication channel 6 to server system 3 (S47).

At this time, terminal device 4′ adds, to the distribution request data, information about the date and time (broadcast date and time) obtained from timer 47 included in terminal device 4′, the user information registered in the first storage unit 43, and the broadcast station information stored in the fourth storage unit 51. Then, with reference to the first storage unit 43, connected system information corresponding to the broadcast station information is obtained and the distribution request data is transmitted to server system 3.

If audience 5 wishes to obtain afterward music data of a broadcast music program which audience 5 is now listening to, or audience 5 is now considering whether or not a request for distribution is to be made (S42, No), the reception date and time information obtained from timer 47 is registered in the fifth storage unit 52 together with the broadcast station information (S44). They are registered through manipulation of operation unit 46 by audience 5. The reception date and time information registered in the fifth storage unit 52 can be called for reference at anytime. When any reception date and time information registered in the fifth storage unit 52 is selected (S45, Yes), the broadcast station information corresponding to the selected date and time information is extracted (S46). With reference to the first storage unit 43, connected system information corresponding to the broadcast station information is obtained and distribution request data is then transmitted to server system 3 (S47).

Server system 3 accordingly receives the distribution request data from the terminal device 4′ (S48), and checks the user information supplied from the user (audience 5) against user information stored in the first storage unit 32 in order to determine if the user who is requesting distribution is a user authorized to use the broadcast distribution system (S49). Preferably, items to be checked include at least the user ID.

If this check indicates that the user requesting distribution has not been authorized to use the broadcast distribution system (S49, No), server system 3 terminates the process. If the user requesting distribution has been authorized to use the broadcast distribution system (S49, Yes), reference is made to information for identifying broadcast station 1 and the broadcast date and time that are supplied from terminal device 4′ as well as the broadcast schedule stored in the third storage unit 34 so as to extract a corresponding music data ID number and transmit, to terminal device 4′ of the user, information about music data (contents with distribution thereof requested by the user) stored in the second storage unit 33 (S50).

Terminal device 4′ then receives the information about the music data from server system 3 (S51), and display unit 42 indicates the whole or part of the information about the music data to direct the user to confirm the contents with distribution thereof requested by the user. (S52). If the user does not desire distribution of the music data (S53, No), this process is ended. If the user determines that distribution of the music data should be executed (S53, Yes), terminal device 4′ transmits to server system 3 information indicating the determination that distribution is to be executed (execute-distribution information) (S54). This execute-distribution information preferably includes the user ID and password registered in the first storage unit 32 of server system 3.

Server system 3 receives the execute-distribution information from terminal device 4′ (S55) and then checks the user information registered in advance in the first storage unit 32 of server system 3 with the user information included in the execute-distribution information supplied from terminal device 4′ to determine if the user is an appropriate (authorized) user or not (S56). If the user is an inappropriate user (S56, No), this process is ended. If the user is an appropriate user (S56, Yes), distribution of the music data with its distribution requested by the user is started (S57).

Terminal device 4′ thus downloads the music data transmitted from server system 3 and stores the music data in the second storage unit 44 of terminal device 4′ (S58). The music data may be stored in the external third storage unit 401 located outside the terminal device 4′.

After downloading of music data by terminal device 4′ (S59, Yes) server system 3 calculates the cost required for distribution of the music data to register the cost as accounting data in the first storage unit 32 in which the user information is registered (S60). Details of the accounting data generated by this distribution are transmitted to terminal device 4′ (S61). Terminal device 4′ receives the accounting data (S62) to break connection with server system 3, and thus distribution of the music data is completed.

Then, the user can use reproduction unit 48 to reproduce the music data stored in the second storage unit 44 or the third storage unit 401 and accordingly listen to desired music output from speaker/headphone 402.

According to the broadcast distribution system of the second embodiment as discussed above, selection for example of broadcast station 1 is unnecessary in downloading of music data so that operation by audience 5 is further simplified, which is an effect achieved in addition to the effects of the first embodiment described above.

Moreover, the reception date and time information is stored in the fifth storage unit 52 so that desired music data can readily be downloaded at any time, which further simplifies the operation by audience 5.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A broadcast distribution device comprising:
a storage unit storing broadcast data according to a broadcast schedule of a broadcast station;
a communication unit transmitting/receiving data to/from an external unit; and
a control unit extracting, when said communication unit receives a request for transmission of the broadcast data, the broadcast data stored in said storage unit according to information about broadcast date and time that is included in the request for transmission and, transmitting the extracted broadcast data by said communication unit.

2. The broadcast distribution device according to claim 1, wherein
said storage unit includes a first storage unit storing user information regarding a user,
said control unit compares a password included in the request for transmission that is received by said communication unit with a password included in the user information stored in said first storage unit to determine whether the extracted broadcast data is to be transmitted or not by said communication unit.

3. The broadcast distribution device according to claim 2, wherein
when said control unit determines that the extracted broadcast data is to be transmitted by said communication unit, said control unit writes, in the user information stored in said first storage unit, accounting data according to the broadcast data.

4. The broadcast distribution device according to claim 1, wherein
said storage unit includes a second storage unit storing the broadcast data and a third storage unit storing the broadcast schedule of the broadcast station, and
when said communication unit receives a broadcast schedule and broadcast data from said broadcast station, said control unit registers the broadcast data in said second storage unit and registers the broadcast schedule in said third storage unit.

5. The broadcast distribution device according to claim 4, wherein
said second storage unit stores information regarding the broadcast data together with the broadcast data, and
said control unit obtains, before said communication unit transmits the extracted broadcast data, information regarding the extracted broadcast data from said second storage unit and transmits the obtained information by said communication unit.

6. A broadcast distribution method for distributing broadcast data comprising the steps of:
storing broadcast data according to a broadcast schedule of a broadcast station;
extracting, when a request for transmission of the broadcast data is received, the stored broadcast data according to information about broadcast date and time that is included in the request for transmission; and
transmitting the extracted broadcast data.

7. A program product for executing by a computer a broadcast distribution method for distributing broadcast data, said broadcast distribution method comprising the steps of:
storing broadcast data according to a broadcast schedule of a broadcast station;
extracting, when a request for transmission of the broadcast data is received, the stored broadcast data according to information about broadcast date and time that is included in the request for transmission; and
transmitting the extracted broadcast data.

8. A computer-readable recording medium having a program recorded thereon that is used for executing by a computer a broadcast distribution method for distributing broadcast data, said broadcast distribution method comprising the steps of:
storing broadcast data according to a broadcast schedule of a broadcast station;
extracting, when a request for transmission of the broadcast data is received, the stored broadcast data according to information about broadcast date and time that is included in the request for transmission; and
transmitting the extracted broadcast data.

9. A broadcast receiver comprising:
a communication unit transmitting/receiving data to/from an external unit; and
a control unit transmitting by said communication unit a request for transmission of broadcast data that includes information about broadcast date and time and receiving by said communication unit the broadcast data following the request for transmission.

10. The broadcast receiver according to claim 9, further comprising a broadcast receiving unit receiving a broadcast from a broadcast station, wherein
said control unit adds, to the request for transmission, information about the broadcast station from which the broadcast is received by said broadcast receiving unit.

11. The broadcast receiver according to claim 9, further comprising a first storage unit storing information about a connected system corresponding to a broadcast station, wherein
said control unit refers to the information about the connected system that is stored in said first storage unit to transmit the request for transmission by said communication unit.

12. The broadcast receiver according to claim 9, further comprising a timer clocking date and time, wherein
said control unit transmits, by said communication unit, current date and time output from said timer as the information about broadcast date and time.

13. The broadcast receiver according to claim 10, further comprising:
a timer clocking date and time; and
a second storage unit storing the information about broadcast date and time, wherein
said control unit stores the information about the broadcast station from which the broadcast is received by said broadcast receiving unit as well as the information about broadcast date and time obtained from said timer in said second storage unit according to an instruction from a user.

14. The broadcast receiver according to claim 13, wherein
said control unit transmits, by said communication unit, information about broadcast date and time that is selected from items stored in said second storage unit as well as information about the broadcast station corresponding to the selected information about broadcast date and time.

15. The broadcast receiver according to claim 9, further comprising a reproduction unit reproducing the broadcast data received by said communication unit.

16. The broadcast receiver according to claim 9, further comprising a display unit indicating information, wherein
said control unit receives information about the broadcast data by said communication unit and displays the received information by said display unit before receiving the broadcast data by said communication unit, and determines whether the broadcast data is to be received or not according to an instruction from a user.

17. The broadcast receiver according to claim 16, wherein
when said control unit determines that the broadcast data is to be received, said control unit transmits user information including a password by said communication unit.

18. A broadcast distribution system including a broadcast distribution device distributing broadcast data and a broadcast receiver receiving the broadcast data that are connected by a network,
said broadcast distribution device including
a first storage unit storing the broadcast data according to a broadcast schedule of a broadcast station,
a first communication unit transmitting/receiving data to/from said broadcast receiver, and
a first control unit extracting, when said first communication unit receives a request for transmission of the broadcast data, the broadcast data stored in said first storage unit according to information about broadcast date and time that is included in the request for transmission and, transmitting the extracted broadcast data by said first communication unit, and
said broadcast receiver including
a second communication unit transmitting/receiving data to/from said broadcast distribution device, and
a second control unit transmitting by said second communication unit a request for transmission of the broadcast data that includes information about broadcast date and time and receiving by said second communication unit the broadcast data following the request for transmission.
